(19) United States
(12) Patent Application Publication
(10) Pub. No.: US 2008/0125034 A1
(43) Pub. Date: May 29, 2008

(54) METHOD OF EXECUTING CONTROL MODE OF RADIO FREQUENCY UNIT IN MOBILE TERMINAL AND MOBILE TERMINAL FOR PERFORMING THE SAME

(75) Inventors: Kyong Su KIM, Seoul (KR); Jin Young KIM, Euiwang-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/771,235

(22) Filed: Jun. 29, 2007

(30) Foreign Application Priority Data
Nov. 23, 2006 (KR) 10-2006-0116332

(51) Int. Cl. H04B 7/26

(52) U.S. Cl. 455/39

(57) ABSTRACT

A method of executing a control mode of a radio frequency (RF) unit in a mobile terminal and a mobile terminal for performing the same are provided. The mobile terminal includes an RF unit to receive electric waves and a controller. The controller compares the intensity of the electric waves received in the RF unit with a reference value of electric wave intensity and the comparison result determines whether the controller turns the RF unit off.

### CROSS REFERENCE TO RELATED APPLICATION

This application claims priority from and the benefit of Korean Patent Application No. 10-2006-0116332, filed on Nov. 23, 2006, which is hereby incorporated by reference for all purposes as if fully set forth herein.

### BACKGROUND OF THE INVENTION

1. Field of the Invention

The present invention relates to a method of executing a control mode of a radio frequency (RF) unit in a mobile terminal and a mobile terminal for performing the same, and more particularly, to a method of executing a control mode of an RF unit for receiving electric waves to control consumption of battery power by turning the RF unit on or off according to the intensity of received electric waves, and a mobile terminal for performing the same.

2. Discussion of the Background

A conventional mobile terminal is activated at time slots to set a communication environment to receive electric waves from a base station. The mobile terminal transmits power according to the intensity of received electric waves. That is, the mobile terminal enables the intensity of electric waves transmitted from the mobile terminal to be weak if the intensity of the received electric waves is strong and enables the intensity of electric waves transmitted from the mobile terminal to be strong if the intensity of the received electric waves is weak, whereby reception efficiency of electric waves may improve.

Because transmission power increases in a weak electric wave area, battery power of the mobile terminal may be rapidly consumed in a weak electric wave area, whereby the battery may not be effectively controlled.

### SUMMARY OF THE INVENTION

The present invention provides a method of controlling an RF unit of a mobile terminal according to the intensity of a signal received in the mobile terminal.

The present invention further provides a method of controlling an RF unit of a mobile terminal in a low electric wave area such that the efficiency of a battery of the mobile terminal may improve.

Additional features of the invention will be set forth in the description which follows, and in part will be apparent from the description, or may be learned by practice of the invention.

The present invention discloses a mobile terminal including an RF unit to receive electric waves and a controller. The controller compares the intensity of the electric waves received in the RF unit with a reference value of electric wave intensity and the comparison result determines whether the controller turns the RF unit off.

The present invention also discloses a method of executing a control mode of an RF unit in a mobile terminal, including receiving electric waves in the RF unit, comparing the intensity of the received electric waves with a reference value of electric wave intensity, and turning off the RF unit if the intensity of the received electric waves is less than the reference value of electric wave intensity.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a mobile terminal for executing a control mode of an RF unit according to an exemplary embodiment of the present invention.

FIG. 2 is a flowchart showing a method of executing a control mode of an RF unit according to an exemplary embodiment of the present invention.

FIG. 3 is a flowchart showing a method of executing a control mode of an RF unit according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

A mobile terminal according to exemplary embodiments of the present invention includes information communication devices and multimedia devices such as a mobile communication terminal, a mobile phone, a Personal Digital Assistant (PDA), and a smart phone, and applications thereof.

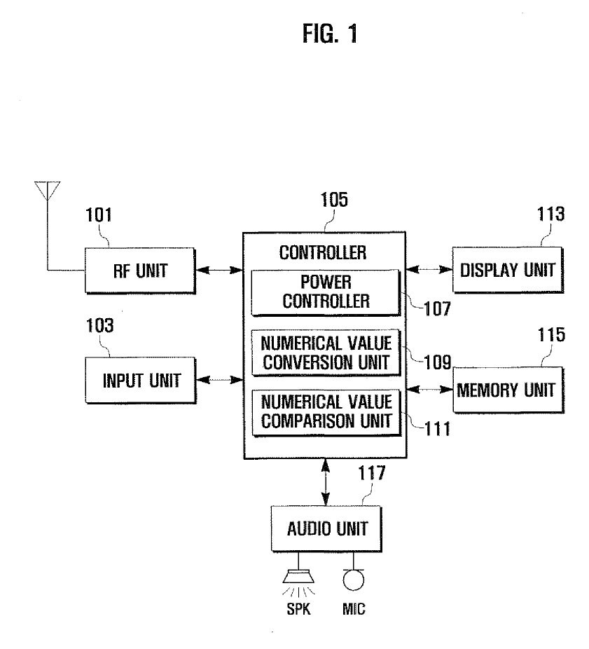

FIG. 1 is a block diagram showing a configuration of a mobile terminal for executing a control mode of an RF unit according to an exemplary embodiment of the present invention.

Referring to FIG. 1, the mobile terminal includes an RF unit 101, an input unit 103, a controller 105, a power controller 107, a numerical value conversion unit 109, a numerical value comparison unit 111, a display unit 113, a memory unit 115, and an audio unit 117.

The RF unit 101 performs wireless communication between the mobile terminal and a mobile communication network. For example, the RF unit 101 transmits and receives voice data, character messages, and multimedia messages through the mobile communication network. The RF unit 101 receives electric waves at an interval that is set by the controller 105 and provides the received electric waves to the controller 105.

The input unit 103 may include a general keypad. Further, the input unit 103 may include a touch screen, a touch pad, and a scroll wheel. The input unit 103 receives a user manipulation signal to control the operation of the mobile terminal and provides the signal to the controller 105.

The controller 105 controls the general operation of units in the mobile terminal. The controller 105 includes a modem and a codec having a transmitter to encode and modulate a signal to be transmitted by the RF unit 101 and a receiver to demodulate and decode the received signal.

Particularly, the controller 105 controls the RF unit 101 to enter a control mode, compares the intensity of electric waves received in the RF unit 101 with a reference value of electric wave intensity, and turns the RF unit 101 on or off according to the compared result. For this, the controller 105 includes a power controller 107, a numerical value conversion unit 109, and a numerical value comparison unit 111. Further, the controller 105 terminates and sustains a control mode of the RF unit 101 in response to an input signal provided by the input unit 103.

The power controller 107 may turn the RF unit 101 off by not supplying power to the RF unit 101 or turn the RF unit 101 on by supplying power to the RF unit 101.

The numerical value conversion unit 109 converts the intensity of electric waves received in the RF unit 101 to a numerical value and provides the numerical value to the numerical value comparison unit 111.

The numerical value comparison unit 111 compares the numerical value, which corresponds to the intensity of received electric waves, with a reference value of electric wave intensity and provides the compared result to the power controller 107.

The display unit 113 displays information relating to the operation state, the operation result, and other information performed in units of the mobile terminal by the f the controller 105. The display unit 113 may include a display device such as a liquid crystal display (LCD), organic light emitting diodes (OLED), or a plasma display panel (PDP).

The controller 105 controls the memory unit 115 to store information (for example, information about a setting state and a menu) related to the operation of the mobile terminal.

The memory unit 115 stores the intensity of received electric waves as a reference value to be referred to when changing to a control mode to turn the RF unit 101 on or off. The memory unit 115 also stores a preset time period and an interval at which electric waves are to be received from a base station in a control mode of the RF unit 101.

The memory unit 115 stores the preset time period as a reference period during which the RF unit 101 is turned on and stores a power saving numerical value of a function, including light brightness and light time, in a power saving mode of the mobile terminal.

The audio unit 117 converts an analog audio signal that is input through a microphone MIC to a digital signal and converts a digital audio signal output from the controller 105 into an analog audio signal and reproduces the signal through a speaker SPK.

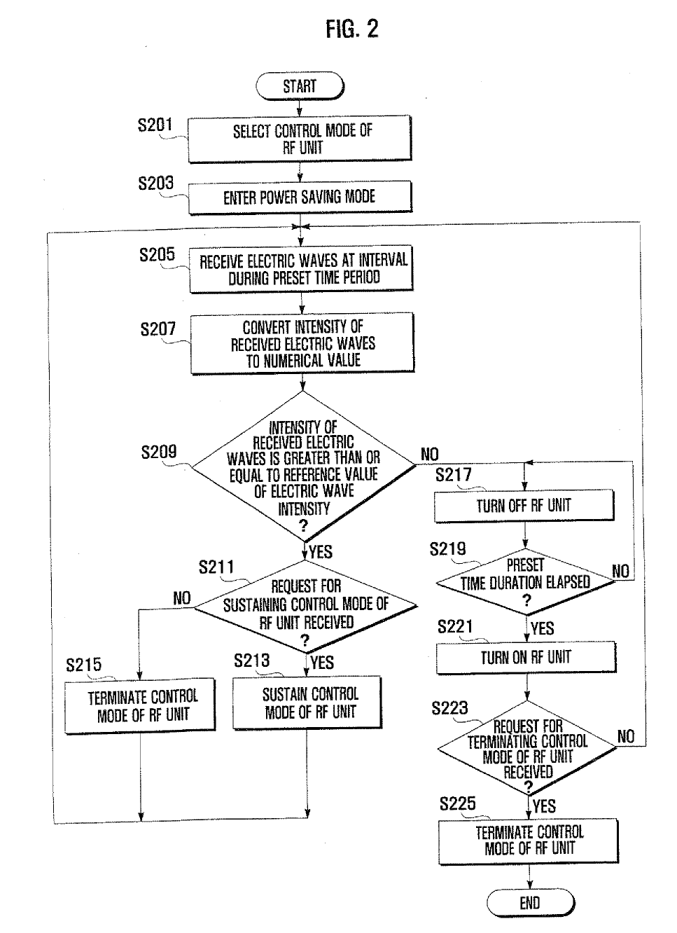

FIG. 2 is a flowchart showing a method of executing a control mode of an RF unit according to an exemplary embodiment of the present invention.

Referring to FIG. 2, a control mode of the RF unit 101 is selected by a user (S201), and the mobile terminal enters a power saving mode (S203). The control mode of the RF unit 101 is a mode that is set to reduce battery power consumption when the mobile terminal moves to a weak electric wave area. The power saving mode is a mode that is set to convert a function such as light brightness and/or light time of the mobile terminal to a preset power saving numerical value.

The controller 105 controls the RF unit 101 to receive electric waves at an interval during the preset time period (S205).

Specifically, the controller 105 controls the RF unit 101 to receive electric waves at intervals before entering the control mode of the RF unit 101, and the intervals may be time slots. In the case of time slots, the mobile terminal receives electric waves from a base station at time slots, each of which corresponds to an intrinsic slot cycle index allocated by the base station according to system settings. Thereafter, the controller 105 controls the RF unit 101 to enter the control mode and receive electric waves at the intervals during the preset time period.

For example, if the preset time period is 3 minutes and the interval is 20 seconds, the controller 105 controls the RF unit 101 to receive electric waves 9 times at intervals of 20 seconds over a 3 minute period. The interval may be a receiving interval (for example, every 20 seconds), the receiving number of times (for example, 9 times), or a time slot.

The controller 105 controls the numerical value conversion unit 109 to measure the intensity of the received electric waves and convert the intensity of the received electric waves to a numerical value, and provides the converted numerical value to the numerical value comparison unit 111 (S207).

The controller 105 controls the numerical value comparison unit 111 to determine whether the intensity of the received electric waves is greater than or equal to a reference value of electric wave intensity (S209). If the intensity of the received electric waves is greater than or equal to the reference value of electric wave intensity, the controller 105 determines whether a request to sustain the control mode of the RF unit 101 has been received (S211). If a request to sustain the control mode of the RF unit 101 is received, the controller 105 sustains the control mode of the RF unit 101 (S213) and continues to receive electric waves. The controller 105 repeats the process by returning to step S205 while sustaining a control mode of the RF unit 101 at step S213.

If a request to sustain the control mode of the RF unit 101 is not received at step S211, the controller 105 terminates the control mode of the RF unit 101 (S215) and the process returns to step S205.

In another exemplary embodiment, if the intensity of the received electric waves is greater than or equal to a reference value of electric wave intensity at step S209, steps S211 and S215 may be omitted, and the process may continue at step S213.

If the intensity of the received electric waves is less than the reference value of electric wave intensity at step S209, the controller 105 turns the RF unit 101 off (S217). When a preset time period has elapsed (219), the controller 105 turns the RF unit 101 on (S221).

The controller 105 determines whether a request to terminate the control mode of the RF unit 101 has been received (S223). If a request to terminate the control mode of the RF unit 101 is not received, the process returns to step S205 and the RF unit 101 continues to receive the electric waves controlled by the controller 105. If a request to terminate the control mode of the RF unit 101 is received, the controller 105 terminates the control mode of the RF unit 101 (S225).

For example, if the preset time period is set to 1 hour, the controller 105 turns the RF unit 101 on after 1 hour has elapsed from the time at which the RF unit 101 was turned off and receives electric waves. A turn-off state of the RF unit 101 is a state in which power is blocked from being supplied to the RF unit 101, and a turn-on state of the RF unit 101 is a state in which power is supplied to the RF unit 101 and thus, electric waves are continuously received.

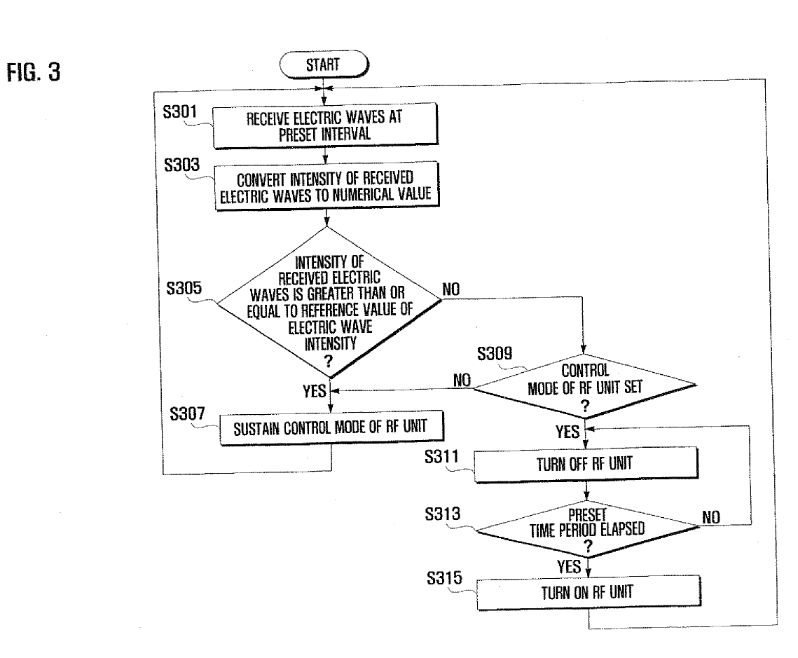

FIG. 3 is a flowchart showing a method of executing a control mode of an RF unit according to another exemplary embodiment of the present invention.

Referring to FIG. 3, the controller 105 controls the RF unit 101 to receive electric waves at intervals (S301). The intervals may be time slots. For example, the mobile terminal may receive electric waves from a base station at time slots, each of which corresponds to an intrinsic slot cycle index allocated by the base station according to system settings.

The controller 105 controls the numerical value conversion unit 109 to measure the intensity of the received electric waves and convert the intensity of the received electric waves to a numerical value (S303). The controller 105 then provides the numerical value to the numerical value comparison unit 111.

The controller 105 controls the numerical value comparison unit 111 to determine whether the numerical value, which corresponds to the intensity of the received electric waves, is greater than or equal to a reference value of electric wave intensity (S305). If the numerical value is greater than or equal to the reference value of electric wave intensity, the controller 105 sustains a control mode of the RF unit 101 (S307), continues to receive the electric waves, and repeats the process by returning to step S301.

If the numerical value is less than the reference value at step S305, the controller 105 determines whether a control mode of the RF unit 101 is set (S309). If a control mode of the RF unit 101 is not set, the process continues at step S307.

If a control mode of the RF unit 101 is set, the controller 105 turns the RF unit 101 off (S311). When the controller 105 determines that a preset time period has elapsed after the RF unit 101 was turned off (S313), the controller 105 turns on the RF unit 101 (S315) and repeats the process by returning to step S301.

As described above, according to exemplary embodiments of the present invention, by controlling the RF unit of the mobile terminal according to the intensity of a received signal, a battery may be effectively managed.

Further, by turning the RF unit off in a weak electric wave area, battery power consumption used to receive electric waves may be reduced.

Further, by turning only the RF unit off in the mobile terminal, another function of the mobile terminal may be used without restriction even when the RF unit of the mobile terminal is turned off.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a radio frequency (RF) unit to receive electric waves; and
a controller to compare the intensity of the electric waves received in the RF unit with a reference value of electric wave intensity,
wherein the comparison result determines whether the controller turns the RF unit off.

2. The mobile terminal of claim 1, wherein the controller comprises:
a numerical value comparison unit to compare the intensity of the received electric waves with the reference value of electric wave intensity; and
a power controller to turn off the RF unit by not supplying power to the RF unit if the intensity of the received electric waves is less than the reference value of electric wave intensity.

3. The mobile terminal of claim 2, wherein the controller further comprises a numerical value conversion unit to convert the intensity of the received electric waves to a numerical value.

4. The mobile terminal of claim 2, wherein the controller turns on the RF unit if, after turning off the RF unit, it determines that a preset time period from a time at which the RF unit was turned off has elapsed.

5. The mobile terminal of claim 4, wherein the controller controls the RF unit to continuously receive the electric waves by sustaining a turn-on state of the RF unit if the intensity of the received electric waves is greater than or equal to the reference value of electric wave intensity.

6. The mobile terminal of claim 1, further comprising an input unit to input a control mode of the RF unit to turn the RF unit on and off.

7. The mobile terminal of claim 6, wherein the controller controls the RF unit to change to a control mode according to the input of the input unit and receive electric waves at a interval during a preset time period.

8. A method of executing a control mode of a radio frequency (RF) unit in a mobile terminal, comprising;
receiving electric waves in the RF unit;
comparing the intensity of the received electric waves with a reference value of electric wave intensity; and
turning off the RF unit if the intensity of the received electric waves is less than the reference value of electric wave intensity.

9. The method of claim 8, further comprising determining whether a control mode of the RF unit is preset if the intensity of the received electric waves is less than the reference value of electric wave intensity.

10. The method of claim 8, further comprising:
determining whether a preset time period has elapsed from a time at which the RF unit is turned off;
turning on the RF unit if the preset time period has elapsed; and
receiving the electric waves in the RF unit.

11. The method of claim 10, further comprising sustaining a turn-on state of the RF unit if the intensity of the received electric waves is greater than or equal to the reference value of electric wave intensity.

12. The method of claim 8, further comprising changing a state of receiving the electric waves at an interval during a preset time period to a state of receiving the electric waves at another interval during the preset time period if a control mode of the RF unit is selected; and
receiving the electric waves at the changed interval during the preset time period in the RF unit.
